(19) United States
(12) Patent Application Publication
(10) Pub. No.: US 2002/0116246 A1
(43) Pub. Date: Aug. 22, 2002

(54) Method for planning a repair of mobile machines

(75) Inventor: Hans-Hermann Wippersteg, Bunde (DE)

Correspondence Address: HUSCH & EPPENBERGER, LLC, Suite 1400, 401 Main Street, Peoria, IL, 61602, US

(73) Assignee: CLAAS Selbstfahrende Erntemaschinen GmbH

(21) Appl. No.: 10/051,876

(22) Filed: Jan. 17, 2002

(30) Foreign Application Priority Data
Jan. 17, 2001 (DE) 101 02 051.1

(51) Int. Cl. G06F 17/60

(52) U.S. Cl. 705/8; 705/28

(57) ABSTRACT

The present invention relates to a method for planning a repair of mobile machines.

According to the invention, a description of the required repair is to be sent together with a machine code from a local computer system to a central processor, so that the latter, using machine-specific data, can produce a proposal on the course of the repair and send it back. Due to the combination of general repair data with machine-specific data, it is possible to plan the repair better, make spares available and monitor execution. The data produced during the repair can advantageously be used for subsequent work steps and analyses.

### TECHNICAL FIELD OF THE INVENTION

The present invention relates to mobile machinery and more specifically to a method for the improved repair of mobile machines.

### BACKGROUND OF THE INVENTION

The present invention relates to a method for planning a repair of a mobile machine.

Today, the repair of mobile machinery is often poorly planned. As a result, delays and extra costs often arise when carrying out the repair of mobile machinery. The mobile machines in question are in particular agricultural, construction and forestry machines. When a machine defect or malfunction has been diagnosed, it is necessary to assess the extent of required repair. This includes determining what parts must be dismantled, what tools and aids are needed for the required repair, what spare parts are required and what is their availability, what technical personnel must be available for the repair and how long will the repair take. An additional difficulty arises from the fact that structural details of mobile machines are modified frequently, even during a current series. Therefore, for a particular functional part there are frequently several designs which do not always fit or are not compatible with the machine to be repaired. Also it is possible for mobile machines to be converted or upgraded during their service life and for such conversions or modifications to equipment to have an effect on the extent of a repair. It is quite common that only during a repair is it discovered that certain parts dismantled during the repair have reached the limit of their technical service life and must be exchanged during the repair. Under these circumstances, such parts must then be ordered subsequently as spares, which can lead to delays. In the course of normal operation, the mobile machine is used by its owner in a continuing work process and repair must be accomplished as quickly as possible. At the present time, whether all the parameters affecting the repair process are correctly detected and whether the correct design and planning measures are taken depends primarily on the knowledge and experience of the workshop personnel. Many problems associated with the repair process arise because, although planning is generally done correctly, specific peculiarities of the machine to be repaired are often overlooked.

### SUMMARY OF THE INVENTION

It is an object of the present invention to improve the method for planning the repair of mobile machines.

The planning of mobile machine repair is improved if the planning is done according to the following steps: entering a repair order for a machine to be repaired in a local computer system, which indicates a code of the machine; sending the repair order and the code of the machine to a central processor via telecommunication means; calling up stored data on this machine by the central processor; generating a repair plan via a computer-assisted means; using the particulars entered on the nature of the repair as well as the specific data on the machine called up previously; producing this repair plan by the central processor; and sending the repair plan to the local computer system via telecommunication means.

### BRIEF DESCRIPTION OF THE DRAWING

Reference is now made to the drawing, which illustrates the best known mode of carrying out the invention and wherein the same reference characters indicate the same or similar parts throughout.

FIG. 1 is a diagram depicting a workshop, having an office equipped with an installed local computer system, a machine to be repaired and a mobile workshop vehicle.

### DETAILED DESCRIPTION

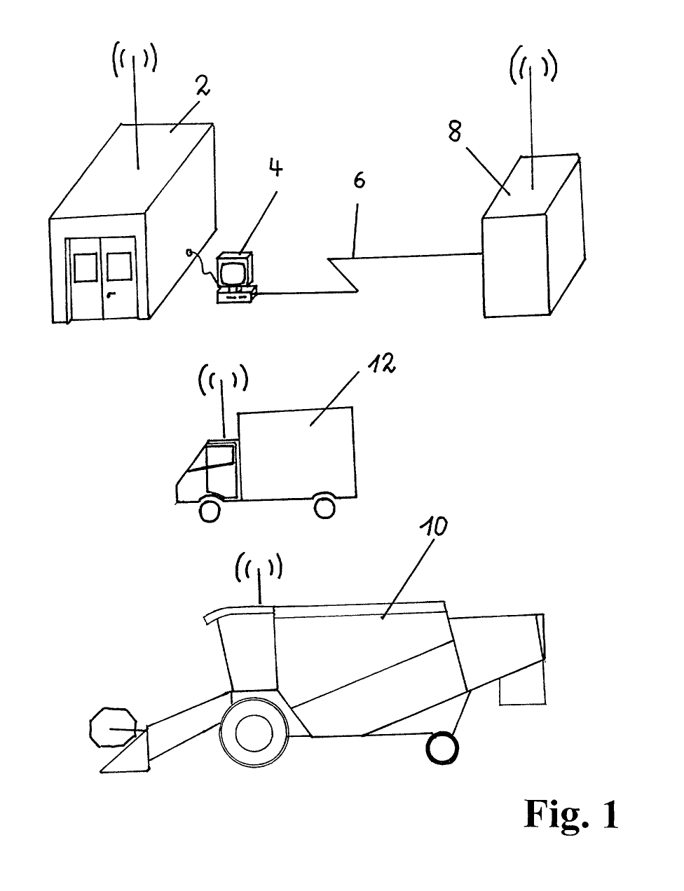

The method will now be described in more detail with the aid of a practical example. FIG. 1 shows a workshop 2 which has an office, wherein a local computer system 4 is installed. The local computer system 4 can exchange data with a central processor 8 via telecommunication means 6, here a cable link. If the workshop 2 receives a repair order for repair of the mobile machine 10, this repair order is entered in the local computer system 4. Together with the code for the machine 10 to be repaired, a description of the extent of the repair to be done is sent via the wire 6 to the central processor 8. As already described above, the central processor 8 processes the repair order sent, using specific data on the mobile machine 10 to be repaired. The central processor 8 then generates a repair proposal and sends the latter back to the local computer system 4. With respect to the central processor 8, it should be noted that not necessarily all relevant data must be stored spatially on this central processor 8, but instead it is also conceivable for the corresponding data and software programs to be available locally in a plurality of servers that are spatially separate from each other. The central processor 8 has a capacity for data exchange with these separately installed servers and can procure correspondingly needed data records and program parts for performing the task. Data exchange does not necessarily have to be effected via cable links, but is possible in any manner technically known in the art, such as for example by radio, GSM or light waves.

Radio systems are of interest for data transmission because mobile units can be included in data exchange. Thus either the local computer system 4 or the central processor 8 can, via radio systems, scan the diagnostic memory of the mobile machine 10 and then update the data stock on this machine 10. Furthermore, it is also possible to include a mobile workshop vehicle 12 in planning and execution of the repair. Thus, the workshop vehicle 12 can be informed when it has to collect particular spare parts, where such parts can be obtained, what tools it has to carry, what repair orders it is to carry out, where such repair orders are to be carried out, how much time is available to it for carrying out the repairs and what peculiarities it has to note when carrying out a repair. In case of such remote control of mobile workshop vehicles, the mobile machine 10 possibly no longer need be transferred to the workshop 2 at all, thus saving valuable operating time. Thus, the machine 10 can be made ready for operation again immediately and effectively at the point of use.

According to a preferred embodiment of the method, a repair order for a machine to be repaired is entered into a local computer system 4, indicating a code of the machine. The repair order and the code of the machine are sent to a central processor 8 via telecommunication means 6. Stored data on this machine are called up by the central processor 8 and are sent to the local computer system 4 via telecommunication means 6. A repair plan is generated with computer assistance, using the particulars entered on the nature of the repair as well as the specific data on the machine. The repair plan is produced by the central processor

Two further embodiments of the method according to the present invention have the advantage that a standardized repair procedure plan, which is linked to machine-specific data, is filed on the central processor 8 or the local computer system 4. As a result, it is possible to use computer-assisted data management to systematically eliminate a large proportion of the error sources which typically hinder an optimal course of the repair.

When the term “repair” is used in this description and in the claims, this is not meant to be limited in its meaning to the exchange of defective parts, but it is intended to be broader in scope. For example, the term “repair”, as used herein, also includes maintenance work. A repair order can advantageously be sent by entry of a number or letter code, keywords or spare parts numbers of the components to be repaired. The code of the machine could, for example, consist of the serial number given by the manufacturer or some other special code. The entry could advantageously be made, for example, by bar codes, a machine-specific chip card which is passed through a chip card reader, or by a similar known technique for identifying codes of objects.

The local computer system 4 may be a computer workstation in a repair shop or in the workshop of the machine owner. It may also be a mobile computer which has facilities for telecommunications, such as a mobile on-board computer that is connected to the machine, or a computer installed in a workshop vehicle that has the capability to approach the machine being repaired.

The central processor 8 can be arranged in the region of the manufacturer of the mobile machine 10. It is also possible to set up such a processor on the premises of large retailers or importers of mobile machines, of companies which hire out or lease machines and also use such services for their own machines, or of service companies which specialize in mobile machinery and which provide consultancy and services for mobile machinery.

The computer-assisted generation of a repair plan can utilize a data bank which contains, for each special repair, the work path for dismounting working parts in order to reach the defective part, information reflecting the exchange of the defective part itself and the work path for restoring the machine to a state ready for operation. All numbers of parts which are moved, the identification of all parts which must be replaced on account of dismounting, a list of parts which might possibly be exchanged due to wear, and the necessary work times, costs and tools needed are all noted for these work paths. Upon entering a special repair, via suitable software, the central processor 8 requests from the data bank the stored data such as work paths, parts numbers, work times and tools. Further, the central processor 8 can process this called-up data if the data stored on the machine to be repaired are present as well. Data on the machine to be repaired can be, for example, the machine model, year of manufacture, equipment, hours of running and/or the previous service history.

Further processing may also advantageously be accomplished by virtue of the data stored, which may be matched with the individual machine data. Thus, suitable software may be used to determine whether particular spare parts numbers are valid for certain spare parts of machines with a given year of manufacture. Such software may also be used to make additional determinations, such as whether a modified work path must be selected because of special machine equipment, whether special tools are required, such as a diagnostic computer with a particular software release, whether certain maintenance tasks are necessary and can be performed for a particular repair, whether individual parts affected by the repair or adjoining parts should also be exchanged as a precaution, etc. Such a choice of special features can already be made before or while the central processor 8 extracts stored data from the data bank. The suitable software solution can be selected and realized by a programming expert with the aid of his technical knowledge, taking into account the special circumstances of data input, holding and generation. Software-assisted matching of the general repair plans with the machine-specific data allows the individual adaptation of a general repair plan wherein the peculiarities of the machine to be repaired are taken into account. This adaptation can be accomplished by the central processor 8, but may also be made possible by the local computer system 4 if the latter receives the centrally stored specific machine data and has the data on the general work plans and adaptation programs.

To be able to produce repair plans on a current and expanded data base, it is advantageous to send data from the diagnostic system of the machine to be repaired, to the central processor 8 or the local computer system 4. In this way particular malfunction details, which can be stored in the diagnostic system, can also be taken into account to establish the repair plan. Thus, the diagnostic code can assist with determining whether the right diagnosis is made for the functional fault of the machine and whether the planned repair will permanently remedy the faults occurring in the machine. Also, it can be determined whether other parts should also be exchanged at the same time as a precaution during repair.

The repair plan may also advantageously include graphic details for carrying out the repair. Thus the repair plan can include pictorial documentation of the whole repair procedure or only part of the repair procedure, with difficult sections or noteworthy peculiarities indicated in a special manner. The graphic details can be attached to the repair plan as a picture or video file.

A repair plan generated with computer assistance is first sent as a proposal to the workshop personnel or the machine owner. The latter can check whether they agree to the proposed repair. The central processor 8 or the local computer system 4 can, with the aid of the list of the parts required for the repair, carry out an availability check of whether and when what spares, tools and personnel capacities are available, and produce a prognosis upon the commencement and during the repair with the aid of this availability check. If an aspect of the repair plan is objected to, e.g. costs too high, commencement of repair too late, lack of available parts, extent of work too great or too small, a modified repair plan can be requested. This process can be repeated until all those involved agree to the resulting repair plan.

If a repair plan has been accepted by all parties, it can form the basis of various subsequent operations. Thus, on acceptance of the repair plan, the warehouse locations of the spare parts required for the repair can be requested automatically and if the warehouse locations differ from the repair location, an automated dispatch order can be sent to the respective warehouse location of the spare parts. Such a dispatch order can also be initiated with software assistance. Moreover the required employees, tools, workshop vehicles and workshop areas can be secured for the duration of the planned repair.

The repair plan can be used by the workshop personnel to document execution of the repair, with the aid of entries in a computer such as the local computer system 4. Thus, individual work steps can be ticked off or provided with remarks. By sending information reflecting the completed tasks to the central processor 8 and indicating the machine code for the particular machine repaired, the maintenance status of the machine can be updated. As a result, it is ensured that when scanning the stored machine data, the most recent jobs on the machine can be taken into account. The documentation of the repair can also be used as a database for invoicing, as a means for comparing the variance on repair times and as a means for comparing the performance of the employees engaged in the machine repair. The repair data can moreover be used on the local computer system 4 or the central processor 8 for statistical analyses on failure probabilities of certain parts, for actual repair times, and for maintaining a store of needed spares and similar applications. The data obtained through repairs can also be used to continuously check the system for its accuracy of predicting malfunctions, for its practical usefulness, and its efficiency, to check the distribution of spare parts, and to constantly improve the system in a self-learning process. The collected database allows targeted analysis of weak points. For the training of customer service and workshop personnel, key training points can be identified and work sequences, work instructions, teaching and learning material can be improved and prepared, within the framework of the process according to the method. The expansion of such provision into accessible interactive animations is possible, as well as linking to call center functions that are particular to the operation. The method according to the invention supplies data for quality statistics of components of the machine, for service life monitoring of components and utilization of such data in systems for preventive maintenance.

The invention in its broader aspects is not limited to the specific steps shown and described but departures may be made therefrom within the scope of the accompanying claims without departing from the principles of the invention and without sacrificing its chief advantages.

What is claimed is:

1. A method for planning a repair of mobile machines, comprising the steps of:
entering a repair order for a machine to be repaired in a local computer system, which indicates a code of the machine;
sending particulars of the repair order and the code of the machine to a central processor via telecommunication means;
retrieving specific data about the machine, which is stored by the central processor;
using the central processor to generate a repair plan which is based upon particulars of the nature of the repair from the repair order and the stored specific data about the machine; and
sending the repair plan to the local computer system via telecommunication means.

2. The method according to claim 1, wherein said stored data relates to the machine's model.

3. The method according to claim 1, wherein said stored data relates to the machine's year of manufacture.

4. The method according to claim 1, wherein said stored data relates to the machine's equipment.

5. The method according to claim 1, wherein said stored data relates to the machine's hours of running.

6. The method according to claim 1, wherein said stored data relates to the machine's service history.

7. The method according to claim 1, wherein said stored data relates to the machine's model, year of manufacture, equipment, hours of running and service history.

8. A method for planning a repair of mobile machines, comprising the steps of:
entering a repair order for a machine to be repaired in a local computer system, which indicates a code of the machine;
sending the code of the machine to a central processor via telecommunication means;
retrieving stored data on the machine, which is stored by the central processor;
sending the stored data that is called up to the local computer system via telecommunication means;
using a computer system to generate a repair plan based upon particulars of the nature of the repair from the repair order and the stored specific data about the machine.

9. The method according to claim 8, wherein said stored data relates to the machine's model.

10. The method according to claim 8, wherein said stored data relates to the machine's year of manufacture .

11. The method according to claim 8, wherein said stored data relates to the machine's equipment.

12. The method according to claim 8, wherein said stored data relates to the machine's hours of running.

13. The method according to claim 8, wherein said stored data relates to the machine's service history.

14. The method according to claim 8, wherein said stored data relates to the machine's model, year of manufacture, equipment, hours of running and service history.

15. The method according to claim 8, including the step of sending data from the machine's diagnostic system to the central processor.

16. The method according to claim 8, including the step of sending data from the machine's diagnostic system to the local computer system.

17. The method according to claim 8, wherein the repair plan includes particulars regarding necessary expenditure of time to be planned for repair of the machine.

18. The method according to claim 8, wherein the repair plan includes particulars regarding parts needed for repair of the machine.

19. The method according to claim 8, wherein the repair plan includes particulars regarding tools needed for repair of the machine.

20. The method according to claim 8, wherein the repair plan includes particulars regarding graphic details necessary for carrying out repair of the machine.

21. The method according to claim 8, wherein the repair plan includes particulars regarding the expenditure of time to be planned, the parts needed, the tools needed and graphic details for carrying out repair of the machine.

22. The method according to claim 8, wherein the repair plan includes proposals for preventive exchange of parts.

23. The method according to claim 8, wherein needed resources are automatically provided upon acceptance of the repair plan.

24. The method according to claim 8, including the step of inputting verification of the execution of each work step of the repair plan into the local computer system.

25. The method according to claim 8, wherein the local computer system produces documentation on the repair carried out from the repair plan and sends the documentation to the central processor, indicating the code of the machine.

26. The method according to claim 8, wherein the local computer system produces an account for repair of the machine, with the aid of the repair plan.

27. The method according to claim 8, wherein the central processor produces an account for repair of the machine, with the aid of the repair plan.
